(19) United States
(12) Patent Application Publication
(10) Pub. No.: US 2026/0139695 A1
(43) Pub. Date: May 21, 2026

(54) ELASTIC BUCKLE BODY

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/392,180

(22) Filed: Nov. 18, 2025

(30) Foreign Application Priority Data
Nov. 21, 2024 (TW) 113144834

(51) Int. Cl. F16B 1/00

(52) U.S. Cl. CPC F16B 1/00

(57) ABSTRACT

The present disclosure provides an elastic buckle body and a buckling method thereof. The elastic buckle body includes a buckling head portion. The buckling head portion is larger than a restriction portion of a buckled object. The elastic buckle body is assembled or arranged on an object by penetrating through or passing through the buckled object, to combine or elastically combine the object with the buckled object. Thus, rapid combination and separation of at least two objects can be completed, and a repeated and rapid combination and separation effect is achieved.

### CROSS-REFERENCE TO RELATED APPLICATION

This non-provisional application claims priority under 35 U.S.C. § 119(a) on Patent Application No(s). 113144834 filed in Taiwan, R.O.C. on Nov. 21, 2024, the entire contents of which are hereby incorporated by reference.

### BACKGROUND OF THE INVENTION

### 1. Field of the Invention

The present disclosure relates to an elastic buckle body, and in particular, to an elastic buckle body capable of repeatedly and rapidly combining and separating at least two objects.

### 2. Description of the Related Art

Generally, when connecting at least two objects, screws are usually used for locking to combine the objects.

In terms of a conventional fixing method, although at least two objects can be fixed and combined in a not easily separable manner. In addition to causing a difficulty in assembling, due to a fixed combining manner of a screw, it is not easy to remove the at least objects.

### BRIEF SUMMARY OF THE INVENTION

An elastic buckle body of the present disclosure can complete rapid combination and separation of at least two objects, and achieve a repeated and rapid combination and separation effect.

To achieve the above objective and other objectives, the present disclosure provides an elastic buckle body, including a buckling head portion. The buckling head portion is larger than a restriction portion of a buckled object. The elastic buckle body is assembled or arranged on an object by penetrating through or passing through the buckled object, to combine or elastically combine the object with the buckled object.

The present disclosure provides another elastic buckle body. The elastic buckle body includes a buckling head portion, a body portion, and an elastic assembly. The body portion is assembled or arranged to an object, and the buckling head portion is configured to buckle or clamp a buckled object, or the elastic buckle body and the object clamp the buckled object, or the buckling head portion and the object clamp the buckled object.

The present application provides a buckling method for another elastic buckle body, including: providing the elastic buckle body with a buckling head portion, first making the elastic buckle body to penetrate or pass through the buckled object to assemble or arrange the elastic buckle body to an object, and then combining or elastically combining the object with the buckled body.

Optionally, the restriction portion is connected to a moving portion to allow a corresponding portion smaller than the buckling head portion to enter.

Optionally, the elastic buckle body further includes a body portion, an elastic assembly, a corresponding portion, and a blocking portion. The buckling head portion is arranged at one end of the corresponding portion. The blocking portion is arranged at another end of the corresponding portion. The corresponding portion is movably arranged on the body portion. Two ends of the elastic assembly respectively resist against the body portion and the blocking portion or the corresponding portion.

Optionally, the elastic buckle body further includes a body portion and an elastic assembly. The restriction portion is connected to a moving portion and a resisting portion. The resisting portion is smaller than the buckling head portion, or the resisting portion is smaller than the restriction portion or is configured to elastically resist against the buckling head portion and the body portion or to provide a lifting distance between the buckling head portion and the body portion.

Optionally, the elastic buckle body further includes a body portion and an elastic assembly. The restriction portion is connected to a resisting portion, or the resisting portion is smaller than the buckling head portion, or the resisting portion is smaller than the restriction portion or is configured to resist against the buckling head portion or to provide a lifting distance between the buckling head portion and the body portion.

Optionally, the elastic buckle body further includes a body portion, and the buckling head portion is movably arranged on the body portion. The body portion is riveted, welded, expanded, or locked to the object, or the body portion is integrally formed with the object.

Optionally, the buckled object or the object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body.

Optionally, the buckling head portion is configured to lift the resisting portion, so that the buckling head portion elastically resists against the buckled object.

Optionally, the restriction portion is connected to a moving portion and a resisting portion. The buckling head portion is larger than the restriction portion. The restriction portion is larger than the moving portion and the resisting portion, or the resisting portion is larger than the moving portion, or the resisting portion is equal to or smaller than the moving portion, or the moving portion is the resisting portion.

Optionally, the object is provided with a heating element. The buckled object is a heat sink, or the buckled object is provided with a heat sink, or the heating element is a chip, an integrated circuit (IC), or an electric body, or the buckled object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body, or the object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body.

Optionally, the buckling head portion is provided with a slope, a curved surface, a flat surface, an arc surface, a stepped surface, a convex portion, or a concave portion, or the buckled object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body, or the object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body.

Optionally, the elastic buckle body further includes a body portion. The buckling head portion is movably arranged on the body portion. The body portion is provided with a material restriction portion, and a mold applies a pressure, so that a material of the object enters or flows into the material restriction portion, to rivet the body portion to the object.

Optionally, the elastic buckle body further includes a body portion. The buckling head portion is movably arranged on the body portion. The body portion is provided with an expansion portion, and a mold applies a pressure, so that the expansion portion deforms and is expanded to the object.

Optionally, the elastic buckle body further includes a body portion. The buckling head portion is movably arranged on the body portion. The body portion is provided with a welding portion, to weld the body portion to the object through the welding portion.

Optionally, the elastic buckle body further includes a body portion. The buckling head portion is movably arranged on the body portion. The body portion is provided with a locking portion, to lock the body portion to the object through the locking portion.

Optionally, the elastic buckle body further includes a body portion. The buckling head portion is movably arranged on the body portion. The body portion is provided with a latching portion. The latching portion is configured to cooperate with a fixing member, so that the body portion is locked to the object through the latching portion and the fixing member.

Optionally, the elastic buckle body further includes a body portion. The buckling head portion is movably arranged on the body portion; and the body portion is integrally formed with the object.

Optionally, the elastic buckle body is assembled to the object from top to bottom or from bottom to top. The elastic buckle body is assembled to the object from top to bottom or from bottom to top through the restriction portion, to limit the buckling head portion to the buckled object.

Optionally, the buckling head portion is configured to clamp the buckled object or the object from top to bottom or from bottom to top together with the body portion, or to simultaneously clamp the buckled object and the object, or the buckling head portion is configured to clamp the buckled object from top to bottom or from bottom to top together with the object, or to simultaneously clamp the buckled object and the object.

Optionally, the restriction portion is of a closed structure, or the restriction portion is of a laterally closed and axially opened structure. The restriction portion is a hole or a slot, or the restriction portion is a step.

Optionally, the buckling head portion and the body portion are abutted and combined by two surfaces of the buckled object, so that the buckling head portion and the body portion clamp the buckled object.

Optionally, the buckled object is configured to be assembled with one, two, or more elastic buckle bodies, or to resist against the buckled object and the object, or to resist against the buckled object or the object.

Optionally, the elastic buckle body further includes a corresponding portion and a blocking portion. The buckling head portion is arranged at one end of the corresponding portion. The blocking portion is arranged at another end of the corresponding portion. The corresponding portion is movably arranged on the body portion. Two ends of the elastic assembly respectively resist against the body portion and the blocking portion.

Optionally, the buckling head portion, the corresponding portion, or the blocking portion is assembled to the body portion from top to bottom or from bottom to top, or the body portion, the corresponding portion, or the blocking portion is assembled to the buckling head portion from top to bottom or from bottom to top, or clamps the buckled object or the object together with the buckling head portion.

Optionally, the buckled object moves to drive a buckling portion of the buckling head portion to cause the buckling portion to buckle or unbuckle a buckled body; or the buckled body is a shell, a handle, a heat sink, a tube body, a chip, a heating element, a plastic body, a connector, an optical fiber, a silicon photon, a tube body, a chip, a heating element, a plastic body, a connector, an optical fiber, a silicon photon, a circuit board, a cabinet body, a sliding rail, a track body, a metal body, or a non-metal body.

Optionally, the buckling head portion further includes a body portion and an elastic assembly that are mutually movably combined. The body portion is assembled or arranged on the object, and the buckling head portion is configured to buckle or clamp the buckled object; or the buckling head portion and the body portion are abutted and combined by two surfaces of the buckled object, so that the buckling head portion and the body portion clamp the buckled object.

Optionally, the restriction portion is connected to an arc-shaped or non-linear moving portion or resisting portion, or the restriction portion is an arc-shaped or non-linear moving portion or resisting portion, or the buckled object has an assembling portion for being assembled to the object, and the assembling portion is used as an axis to make the buckling head portion perform arc-shaped or non-linear movement or buckling in the moving portion or in the resisting portion or perform arc-shaped or non-linear lifting or buckling through the resisting portion.

Optionally, the restriction portion is connected to an arc-shaped or non-linear moving portion or resisting portion, or the restriction portion is an arc-shaped or non-linear moving portion or resisting portion, or the buckled object has an assembling portion for being assembled to the object, and the assembling portion is used as an axis to make the buckling head portion perform arc-shaped or non-linear movement or buckling in the moving portion or in the resisting portion or perform arc-shaped or non-linear lifting or buckling through the resisting portion, or the buckled object has a pushing portion, and the pushing portion is configured to push a pushing body to drive the object.

Optionally, the restriction portion is connected to an arc-shaped or non-linear moving portion or resisting portion, or the restriction portion is an arc-shaped or non-linear moving portion or resisting portion, or the buckled object has an assembling portion for being assembled to the object, and the assembling portion is used as an axis to make the buckling head portion perform arc-shaped or non-linear movement or buckling in the moving portion or in the resisting portion or perform arc-shaped or non-linear lifting or buckling through the resisting portion. Or the buckled object has a pushing portion. The pushing portion is configured to push a pushing body to drive the object, or the elastic buckle body has a buckling portion to buckle a buckled body, or when the resisting portion performs the arc-shaped or non-linear motion, the buckling portion is lifted to make the object or the buckled object move or to restrain the object or the buckled object, or the buckling portion performs buckling motion at two buckling positions of the buckled body or is configured to control the buckled object to be in an opening position or a closing position of the pushing portion or to control the buckling portion to buckle or unbuckle the buckled body.

Optionally, the restriction portion is connected to an arc-shaped or non-linear moving portion or resisting portion, or the restriction portion is an arc-shaped or non-linear moving portion or resisting portion, or the object has a shaft body to make the buckling head portion perform arc-shaped or non-linear movement or buckling in the moving portion or in the resisting portion or perform arc-shaped or non-linear lifting or buckling through the resisting portion. Or the buckled object has a pushing portion, or the pushing portion is configured to push a pushing body to drive the object, or the elastic buckle body has a buckling portion to buckle a buckled body, or the buckling portion is configured to buckle or unbuckle a buckled body to restrict or release movement of the object, or the object or the buckled body is a case or a main board, or is configured to lift the buckling portion when the resisting portion performs arc-shaped or non-linear motion; or the buckling portion performs buckling motion at two buckling positions of the buckled body or is configured to control the buckled object to be in an opening position or a closing position of the pushing portion or to control the buckling portion to buckle or unbuckle the buckled body.

Optionally, the buckling head portion is provided with a position-limiting portion; the position-limiting portion is configured to: limit the buckled object and push a lifting portion through a push-upward portion, to cause the position-limiting portion to be separated from a restriction portion of the buckled object; and the restriction portion is larger than the position-limiting portion to move the buckled object or move an object.

Optionally, the lifting portion is configured to be buckled into the push-upward portion or the object, or the lifting portion is configured to be buckled into another restriction portion.

Optionally, the position-limiting portion is a step portion, a vertical portion, a slope portion, or a right-angle portion.

Optionally, the restriction portion is connected to a moving portion to allow a corresponding portion smaller than the buckling head portion to enter.

Optionally, the elastic buckle body further includes a body portion, an elastic assembly, a corresponding portion, or a blocking portion, or the buckling head portion is arranged at one end of the corresponding portion, or the blocking portion is arranged at another end of the corresponding portion, or the corresponding portion is movably arranged on the body portion, or two ends of the elastic assembly respectively resist against the body portion and the blocking portion or the corresponding portion.

Optionally, the restriction portion is connected to a moving portion and a resisting portion, or the buckling head portion is larger than the resisting portion, or the resisting portion is larger than the moving portion and the resisting portion, or the resisting portion is larger than the moving portion, or the resisting portion is equal to or smaller than the moving portion, or the moving portion is the resisting portion.

The present application provides a buckling method for another elastic buckle body, including: providing the elastic buckle body with a buckling head portion, first making the elastic buckle body to penetrate or pass through a buckled object to assemble or arrange the elastic buckle body to an object, and then combining or elastically combining the object with the buckled object. Or the elastic buckle body is assembled to the object from top to bottom or from bottom to top, to limit the buckling head portion to the buckled object. Or the buckling head portion is configured to clamp the buckled object or the object from top to bottom or from bottom to top together with the body portion. Or the restriction portion is of a closed structure, or the restriction portion is of a laterally closed and axially opened structure. The restriction portion is a hole or a slot, or the restriction portion is a step. Or a buckling head portion, a body portion, an elastic assembly that are mutually movably combined are included. The body portion is assembled or arranged on the object, and the buckling head portion is configured to buckle or clamp the buckled object. Or the buckling head portion and the body portion are abutted and combined by two surfaces of the buckled object, so that the buckling head portion and the body portion clamp the buckled object. Or the buckled object is configured to assemble one, two, or more elastic buckle bodies, so that the buckled object is normally elastically arranged on the object or normally resists against the object. Or the elastic buckle body further includes a corresponding portion and a blocking portion. The buckling head portion is arranged at one end of the corresponding portion. The blocking portion is arranged at another end of the corresponding portion. The corresponding portion is movably arranged on the body portion. Two ends of the elastic assembly respectively resist against the body portion and the blocking portion. Or the buckling head portion, the corresponding portion, or the blocking portion is assembled to the body portion from top to bottom or from bottom to top, or the body portion, the corresponding portion, or the blocking portion is assembled to the buckling head portion from top to bottom or from bottom to top, or clamps the buckled object or the object together with the buckling head portion, or clamps the buckled object together with the buckling head portion and the object. Or the buckled object moves to drive a buckling portion of the buckling head portion to cause the buckling portion to buckle or unbuckle a buckled body; or the buckled object is a shell, a handle, a heat sink, a tube body, a chip, a heating element, a plastic body, a connector, an optical fiber, a silicon photon, a tube body, a chip, a heating element, a plastic body, a connector, an optical fiber, a silicon photon, a circuit board, a cabinet body, a sliding rail, a track body, a metal body, or a non-metal body.

The present disclosure provides a buckling method for another elastic buckle body, including: providing the elastic buckle body with a buckling head portion, and assembling or arranging the elastic buckle body to an object. The buckling head portion is larger than a restriction portion of a buckled object or is configured to combine or elastically combine the object with the buckled object. The restriction portion is connected to an arc-shaped or non-linear moving portion or resisting portion, or the restriction portion is an arc-shaped or non-linear moving portion or resisting portion, or the buckled object has an assembling portion for being assembled to the object, and the assembling portion is used as an axis to make the buckling head portion perform arc-shaped or non-linear movement or buckling in the moving portion or in the resisting portion, or the object has a shaft body to make the buckling head portion perform arc-shaped or non-linear movement or buckling in the moving portion or in the resisting portion or perform arc-shaped or non-linear lifting or buckling through the resisting portion. Or the restriction portion is connected to an arc-shaped or non-linear moving portion or resisting portion, or the buckled object has an assembling portion for being assembled to the object, and the assembling portion is used as an axis to make the buckling head portion perform arc-shaped or non-linear movement or buckling in the moving portion or in the resisting portion or perform arc-shaped or non-linear lifting or buckling through the resisting portion, or the buckled object has a pushing portion, and the pushing portion is configured to push a pushing body to drive the object. Or the restriction portion is connected to an arc-shaped or non-linear moving portion or resisting portion, or the restriction portion is an arc-shaped or non-linear moving portion or resisting portion, or the buckled object has an assembling portion for being assembled to the object, and the assembling portion is used as an axis to make the buckling head portion perform arc-shaped or non-linear movement or buckling in the moving portion or the resisting portion or perform arc-shaped or non-linear lifting or buckling through the resisting portion, or the buckled object has a pushing portion, and the pushing portion is configured to push a pushing body to drive the object. Or the elastic buckle body has a buckling portion to buckle a buckled body, or the buckling portion is configured to buckle or unbuckle a buckled body to restrict or release movement of the object, or the object or the buckled body is a case or a main board, or is configured to lift the buckling portion when the resisting portion performs arc-shaped or non-linear motion, to make the buckled object move; or the buckling portion performs buckling motion at two buckling positions of the buckled body or is configured to control the buckled object to be in an opening position or a closing position of the pushing portion or to control the buckling portion to buckle or unbuckle the buckled body.

### BRIEF DESCRIPTION OF THE DRAWINGS

To describe the technical solutions in the embodiments of the present disclosure or in the prior art more clearly, the following will briefly introduce the accompanying drawings required to be used in the embodiments. Apparently, the accompanying drawings in the following description show merely some embodiments of the present disclosure, and a person of ordinary skill in the art may still derive other drawings from the accompanying drawings without creative efforts.

FIG. 1 is a schematic diagram of a sectional-view state of a first embodiment of the present disclosure.

FIG. 2 is a schematic diagram of a top-view state of a first embodiment of the present disclosure.

FIG. 3 is a schematic diagram of a cross-sectional state of a second embodiment of the present disclosure.

FIG. 4 is a schematic diagram of a top-view state of a second embodiment of the present disclosure.

FIG. 5 is a schematic diagram of an assembling state of a third embodiment of the present disclosure.

FIG. 6 is a schematic diagram of an assembling state of a fourth embodiment of the present disclosure.

FIG. 7 is a schematic diagram of an assembling state of a fifth embodiment of the present disclosure.

FIG. 8 is a schematic diagram of an assembling state of a sixth embodiment of the present disclosure.

FIG. 9 is a schematic diagram of an assembling state of a seventh embodiment of the present disclosure.

FIG. 10 is a schematic diagram of an assembling state of an eighth embodiment of the present disclosure.

FIG. 11 is a schematic diagram of an assembling state of a ninth embodiment of the present disclosure.

FIG. 12 is a schematic diagram of an assembling state of a tenth embodiment of the present disclosure.

FIG. 13 is a schematic diagram of an assembling state of an eleventh embodiment of the present disclosure.

FIG. 14 is a schematic diagram of a sectional-view state of a twelfth embodiment of the present disclosure.

FIG. 15 is a schematic diagram of a top-view state of a twelfth embodiment of the present disclosure.

FIG. 16 is a schematic diagram of a sectional-view state of a thirteenth embodiment of the present disclosure.

FIG. 17 is a schematic diagram of a top-view state of a thirteenth embodiment of the present disclosure.

FIG. 18 is a schematic diagram I of a usage state of a fourteenth embodiment of the present disclosure.

FIG. 19 is a schematic diagram II of a usage state of a fourteenth embodiment of the present disclosure.

FIG. 20 is a schematic diagram of a usage state of a fifteenth embodiment of the present disclosure.

FIG. 21 is a schematic diagram of a usage state of a sixteenth embodiment of the present disclosure.

FIG. 22 is a schematic diagram of a usage state of a seventeenth embodiment of the present disclosure.

FIG. 23 is a schematic diagram of a sectional-view state of an eighth embodiment of the present disclosure.

FIG. 24 is a schematic diagram of a top-view state of an eighth embodiment of the present disclosure.

FIG. 25 is a schematic diagram of a sectional-view state of a nineteenth embodiment of the present disclosure.

FIG. 26 is a schematic diagram of a top-view state of a nineteenth embodiment of the present disclosure.

FIG. 27 is a schematic diagram of different forms of a position-limiting portion of the present disclosure.

FIG. 28 is a schematic diagram of a sectional-view state of a twentieth embodiment of the present disclosure.

FIG. 29 is a schematic diagram of a top-view state of a twentieth embodiment of the present disclosure.

### DETAILED DESCRIPTION OF THE INVENTION

An elastic buckle body 1 of the embodiments of the present disclosure is further described below with reference to the accompanying drawings.

The aforementioned and other technical content, features, and effects related to this disclosure will be clearly presented in the detailed description of the preferred embodiments in conjunction with the reference drawings below. It is worth mentioning that the directional terms mentioned in the following embodiments, such as up, down, left, right, front, or back, are only referring to directions of the accompanying drawings. Therefore, the directional terms used herein are intended to illustrate rather than limit this disclosure. In addition, in the following embodiments, identical or similar components will be labeled with the same or similar reference numerals.

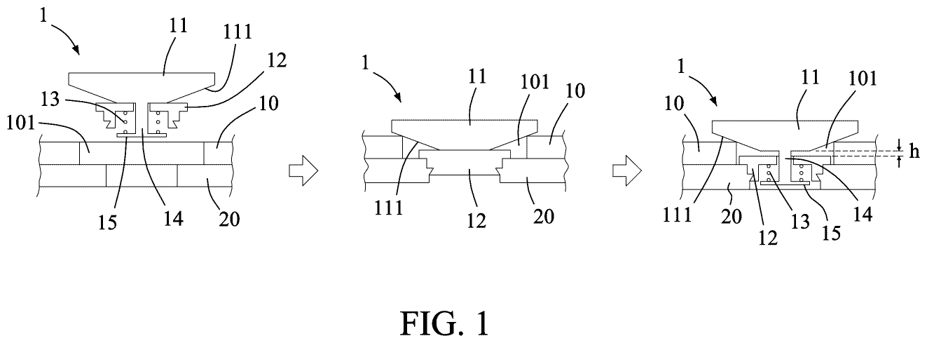

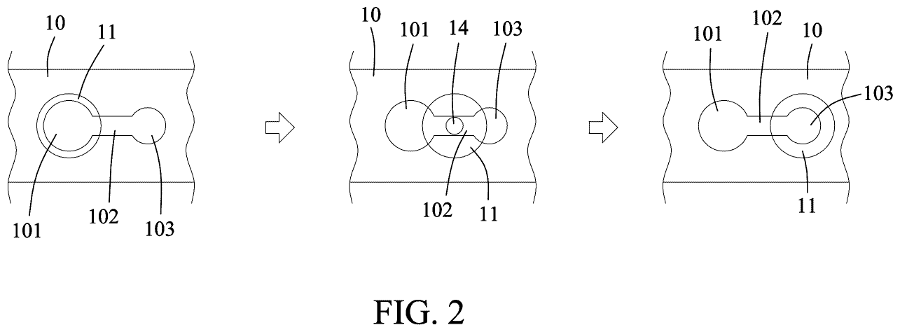

Referring to FIG. 1 and FIG. 2, as shown in the figures, the present disclosure provides an elastic buckle body 1 and a buckling method therefor. The elastic buckle body 1 includes a buckling head portion 11. The buckling head portion 11 is larger than a restriction portion 101 of a buckled object 10. The elastic buckle body 1 is assembled or arranged on an object 20 by penetrating or passing through the buckled object 10 (or another object), so that the object 20 is combined (or elastically combined) with the buckled object 10. In addition, in this embodiment of the present disclosure, the elastic buckle body 1 and the object 20 can clamp the buckled object 10, or the buckling head portion 11 and the object 20 clamp the buckled object 10. In this way, rapid combination and separation of at least two objects (the buckled object 10 and the object 20) can be completed, and a repeated and rapid combination and separation purpose is achieved.

The buckling method of the present disclosure includes: first making the elastic buckle body 1 to penetrate or pass through the buckled object 10. For example: the elastic buckle body 1 can be assembled to the object 20 as required from top to bottom or from bottom to top, so that the buckling head portion 11 is limited to the buckled object 10 to assemble or arrange the elastic buckle body 1 on the object 20. Then, the object 20 and the buckled object 10 are combined (or elastically combined). In this way, rapid combination and separation of at least two objects (the buckled object 10 and the object 20) can be completed, and a repeated and rapid combination and separation purpose is achieved.

In addition to the above embodiment, in one embodiment of the present disclosure, a difference from the above embodiment is that the buckling head portion 11 can be used to clamp the buckled object 10 from top to bottom (or from bottom to top) together with the object 20, or to simultaneously clamp the buckled object 10 and the object 20. In this way, rapid combination and separation of at least two objects (the buckled object 10 and the object 20) can be completed, and a repeated and rapid combination and separation purpose is achieved.

In addition to the above embodiment, in one embodiment of the present disclosure, a difference from the above embodiment is that the buckled object 10 or the object 20 may be a shell, a handle, a heat sink, a tube body, a chip, a heating element, a plastic body, a connector, an optical fiber, a silicon photon, a circuit board, a cabinet body, a sliding rail, a track body, a metal body, or a non-metal body. In this way, the buckled object 10 and the object 20 can better meet requirements of manufacturing and use.

In addition to the above embodiment, in one embodiment of the present disclosure, a difference from the above embodiment is that the elastic buckle body 1 further includes a body portion 12, an elastic assembly 13, a corresponding portion 14, and a blocking portion 15. The buckling head portion 11 is arranged at one end of the corresponding portion 14. The blocking portion 15 is arranged at another end of the corresponding portion 14. The corresponding portion 14 is movably arranged on the body portion 12. Two ends of the elastic assembly 13 respectively resist against the body portion 12 and the blocking portion 15.

Based on the above embodiment, during use, the body portion 12 of the elastic buckle body 1 can penetrate or pass through the buckled object 10, and the body portion 12 is assembled on the object 20. Then, the buckling head portion 11 buckles or clamps the buckled object 10 after entering a restriction portion 101 of the buckled object 10. In this way, rapid combination and separation of at least two objects (the buckled object 10 and the object 20) can be completed, and a repeated and rapid combination and separation purpose is achieved.

In addition to the above embodiment, in one embodiment of the present disclosure, a difference from the above embodiment is that the restriction portion 101 is connected to a moving portion 102 and a resisting portion 103. The buckling head portion 11 is greater than the restriction portion 101. The restriction portion 101 is larger than the moving portion 102 and the resisting portion 103. In other different embodiments, the resisting portion 103 can alternatively be larger than the moving portion 102, or the resisting portion 103 is equal to or smaller than the moving portion 102, or the moving portion 102 is the resisting portion 103. In addition, the restriction portion 101 can be of a closed structure. For example: the restriction portion can be a hole or a slot of a laterally closed and axially opened structure (or the restriction portion 101 is a step).

Based on the above embodiment, during use, the body portion 12 of the elastic buckle body 1 can penetrate or pass through the buckled object 10, and the body portion 12 is assembled on the object 20. Then, the buckling head portion 11 enters the restriction portion 101 of the buckled object 10, and then the corresponding portion 14 moves to the resisting portion 103 via the moving portion 102, so that the buckling head portion 11 resists against the resisting portion 103 and then buckles or clamps the buckled object 10. In this way, rapid combination and separation of at least two objects (the buckled object 10 and the object 20) can be completed, and a repeated and rapid combination and separation purpose is achieved.

In addition to the above embodiment, in one embodiment of the present disclosure, a difference from the above embodiment is that the resisting portion 103 is smaller than the buckling head portion 11 and the restriction portion 101, so as to utilize the cooperation of the elastic assembly 13 to provide a lifting distance h between the buckling head portion 11 and the body portion 12. When the corresponding portion 14 moves to the resisting portion 103 via the moving portion 102, the resisting portion 103, the buckling head portion 11, and the body portion 12 can form elastic resisting, thereby lifting the buckling head portion 11 at the resisting portion 103 and allowing the buckling head portion 11 to elastically resist against the buckled object 10 by the appropriate lifting distance h. In this way, rapid combination and separation of at least two objects (the buckled object 10 and the object 20) can be completed, and a repeated and rapid combination and separation purpose is achieved.

In addition to the above embodiment, in one embodiment of the present disclosure, a difference from the above embodiment is that the body portion 12 can be riveted, welded, expanded, or locked to the object 20 as required, or the body portion 12 is integrally formed with the object 20. In this way, the body portion 12 and the object 20 have good assembling stability, so that the body portion 12 is stably arranged on the object 20 to meet a requirement of an actual operation.

In addition to the above embodiment, in one embodiment of the present disclosure, a difference from the above embodiment is that the buckling head portion 11 is provided with a slope 111, a curved surface, a plane, an arc surface, a step surface, a convex portion, or a concave portion. In this way, the buckling head portion 11 can easily move between the position of the moving portion 102 and the position of the resisting portion 103 at least through the slope 111, so that the buckling head portion 11 meet a requirement of an actual operation.

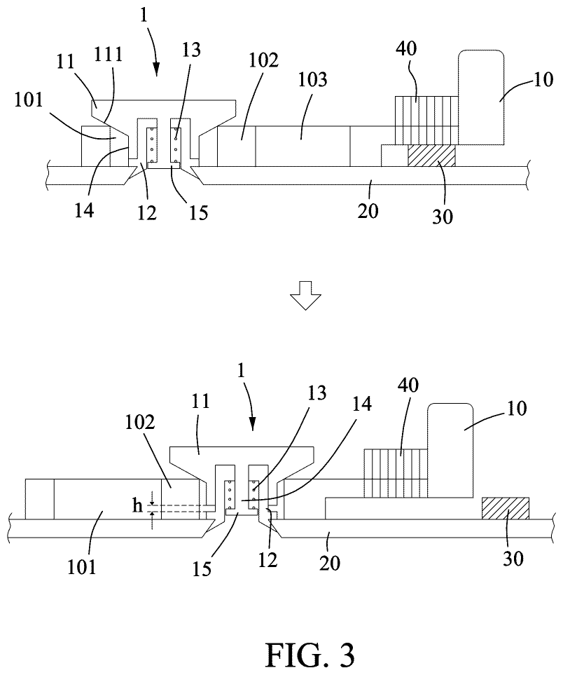

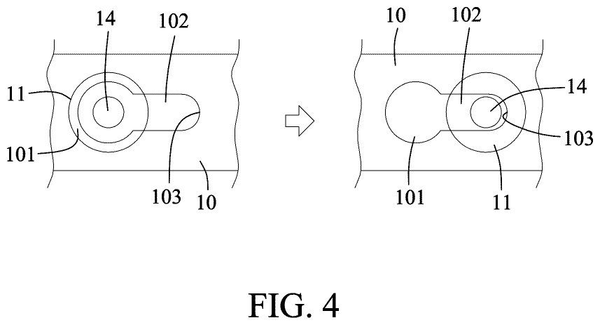

Referring to FIG. 3 and FIG. 4, as shown in the figures: In addition to the above embodiment, in one embodiment of the present disclosure, a difference from the above embodiment is that the buckled object 10 can be a handle, and the object 20 is provided with a heating element 30 (such as a chip, an IC, or an electric body). The buckled object 10 can be provided with a heat sink 40 (or the buckled object 10 can be a heat sink). In this way, during use, the buckling head portion 11 can enter the restriction portion 101 of the buckled object 10, and then the corresponding portion 14 moves to the resisting portion 103 via the moving portion 102, so that the buckling head portion 11 resists against the resisting portion 103 and then buckles or clamps the buckled object 10. Meanwhile, the heat sink 40 resists against the heating element 30, so that the heat sink 40 dissipates heat of the heating element 30. In this way, rapid combination and separation of the heating element 30 and the heat sink 40 can be completed, and a repeated and rapid combination and separation purpose is achieved.

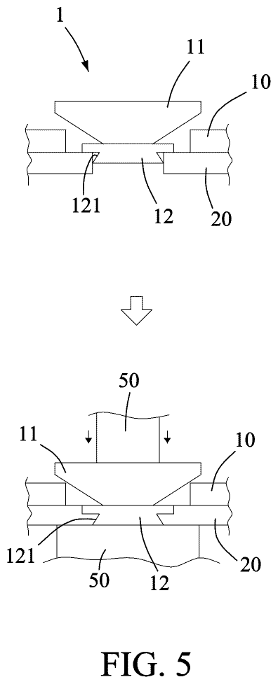

Referring to FIG. 5, as shown in the figure: In addition to the above embodiment, in one embodiment of the present disclosure, a difference from the above embodiment is that the body portion 12 is provided with a material restriction portion 121, and a mold 50 applies a pressure to the buckling head portion 11, the body portion 12, and the object 20 upwards and downwards, so that a material of the object 20 enters or flows into the material restriction portion 121, to rivet the body portion 12 to the object 20. In this way, the body portion 12 and the object 20 have good assembling stability, so that the body portion 12 is stably arranged on the object 20 to meet a requirement of an actual operation.

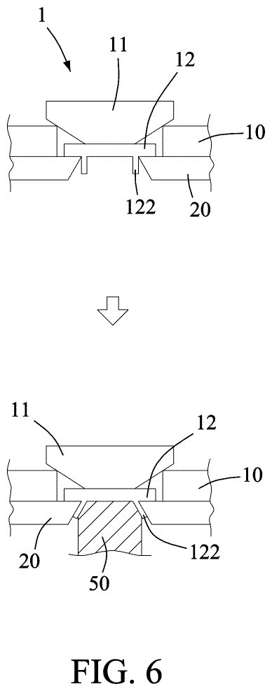

Referring to FIG. 6, as shown in the figure: In addition to the above embodiment, in one embodiment of the present disclosure, a difference from the above embodiment is that the body portion 12 is provided with an expansion portion 122, and a mold 50 applies a pressure from bottom to top to the expansion portion 122, so that the expansion portion 122 deforms and is expanded to the object 20. In this way, the body portion 12 and the object 20 have good assembling stability, so that the body portion 12 is stably arranged on the object 20 to meet a requirement of an actual operation.

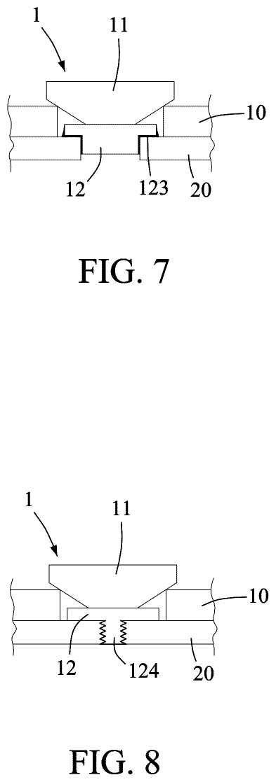

Referring to FIG. 7, as shown in the figure: In addition to the above embodiment, in one embodiment of the present disclosure, a difference from the above embodiment is that the body portion 12 is provided with a welding portion 123, and the body portion 12 is welded to the object 20 through the welding portion 123. In this way, the body portion 12 and the object 20 have good assembling stability, so that the body portion 12 is stably arranged on the object 20 to meet a requirement of an actual operation.

Referring to FIG. 8, as shown in the figure: In addition to the above embodiment, in one embodiment of the present disclosure, a difference from the above embodiment is that the body portion 12 is provided with a locking portion 124, and the body portion 12 is locked to the object 20 through the locking portion 124. In this way, the body portion 12 and the object 20 have good assembling stability, so that the body portion 12 is stably arranged on the object 20 to meet a requirement of an actual operation.

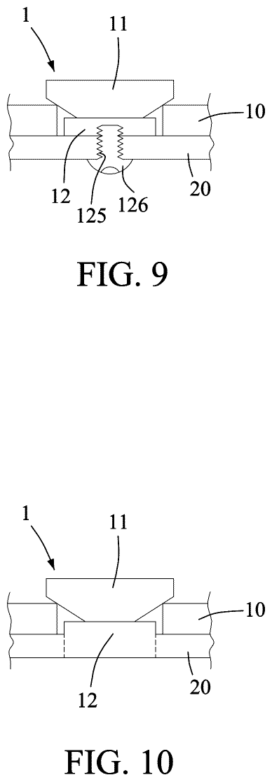

Referring to FIG. 9, as shown in the figure: In addition to the above embodiment, in one embodiment of the present disclosure, a difference from the above embodiment is that the body portion 12 is provided with a latching portion 125. The latching portion 125 is configured to cooperate with a fixing member 126, so that the body portion 12 is locked to the object 20 through the latching portion 125 and the fixing member 126. In this way, the body portion 12 and the object 20 have good assembling stability, so that the body portion 12 is stably arranged on the object 20 to meet a requirement of an actual operation.

Referring to FIG. 10, as shown in the figure: In addition to the above embodiment, in one embodiment of the present disclosure, a difference from the above embodiment is that the body portion 12 is integrally formed with the object 20. In this way, the body portion 12 and the object 20 have good assembling stability, so that the body portion 12 is stably arranged on the object 20 to meet a requirement of an actual operation.

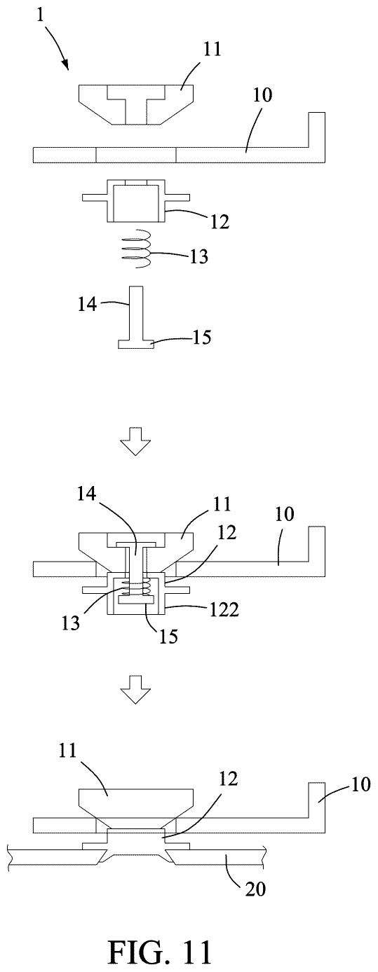

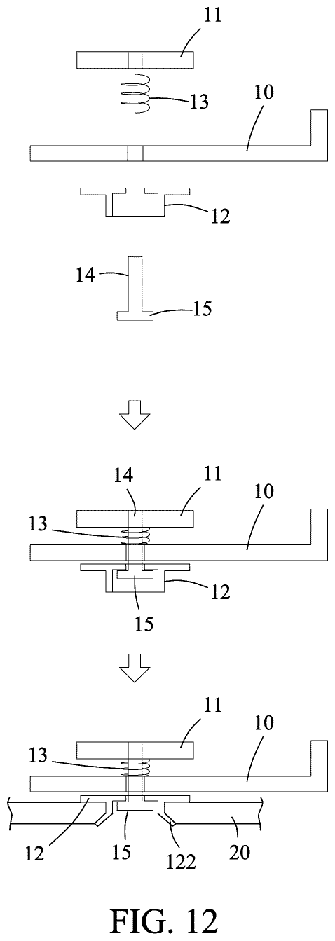

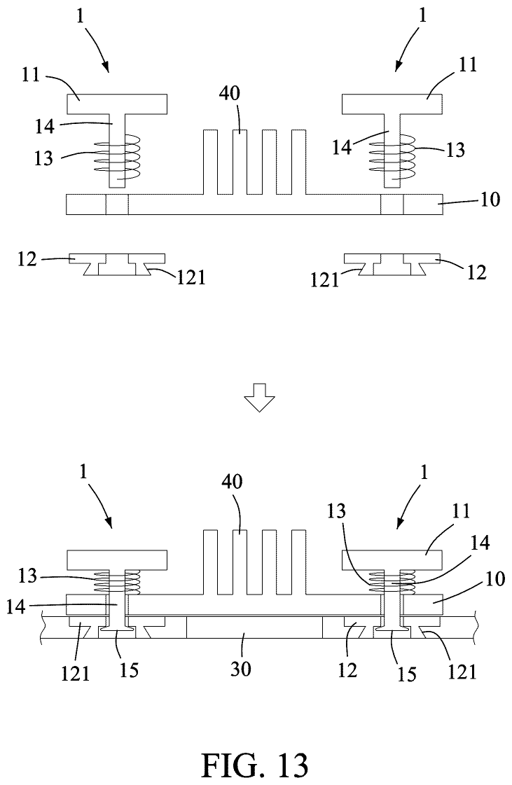

Referring to FIG. 11 and FIG. 12, as shown in the figures: In addition to the above embodiment, in one embodiment of the present disclosure, a difference from the above embodiment is that the buckling head portion 11 and the body portion 12 are abutted and combined by two surfaces of the buckled object 10, so that the buckling head portion 11 and the body portion 12 clamp the buckled object 10. The buckled object 10 can be a handle, and the body portion 12, the corresponding portion 14, and blocking portion 15 are assembled to the buckling head portion 11 from bottom to top (or from top to bottom). Two ends of the elastic assembly 13 can respectively resist against the body portion 12 and blocking portion 15, and the corresponding portion 14 can be assembled to the buckling head portion 11 in an expansion, buckling, or riveting manner (as shown in FIG. 11). Or the two ends of the elastic assembly 13 can respectively resist against the buckling head portion 11 and the buckled object 10 (as shown in FIG. 12). In this way, the elastic buckle body 1 of the present disclosure can better meet a need of practical use.

Referring to FIG. 13, as shown in the figure: In addition to the above embodiment, in one embodiment of the present disclosure, a difference from the above embodiment is that the buckled object 10 can be a heat sink 40, and the buckled object 10 is configured to assemble one, two, or more elastic buckle bodies 1, so that the buckled object 10 is normally elastically arranged on the object 20 or normally resists against the object 20, while the buckling head portion 11, the corresponding portion 14, and the blocking portion 15 are assembled from top to bottom on the body portion 12. The blocking portion 15 can be assembled from top to bottom on the body portion 12 and is then expanded and formed, so that the buckling head portion 11 and the body portion 12 clamp the buckled object 10. Or the buckling head portion 11, the corresponding portion 14, and the blocking portion 15 are assembled from bottom to top to the buckling head portion 11, so that the buckling head portion 11 clamps the buckled object 10 (the other object or the object 20). In this way, the elastic buckle body 1 of the present disclosure can better meet a need of practical use.

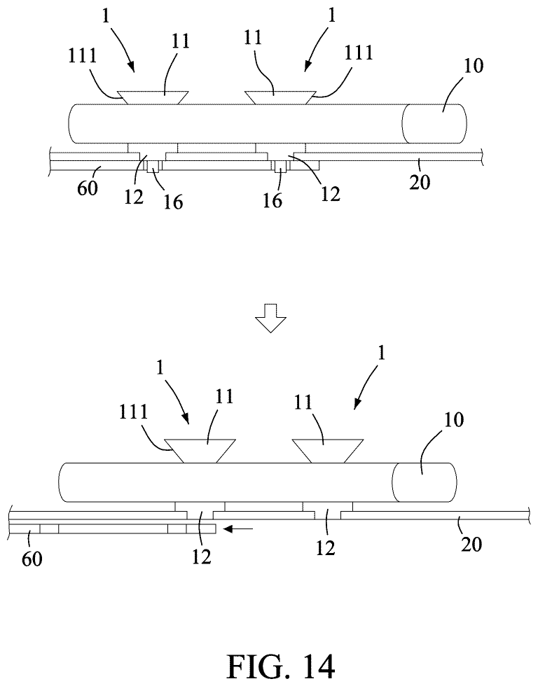

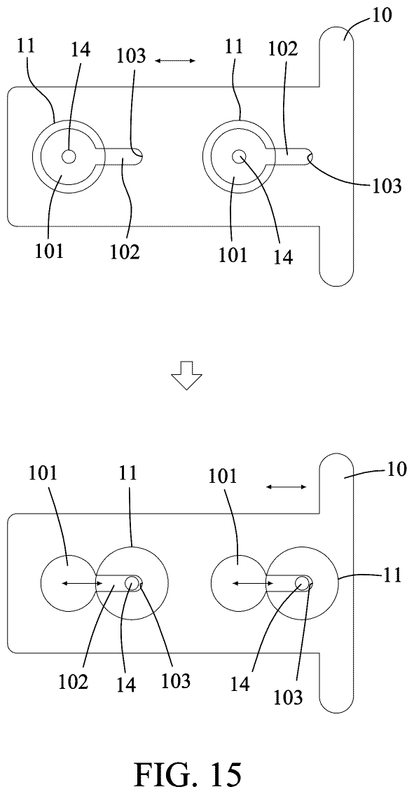

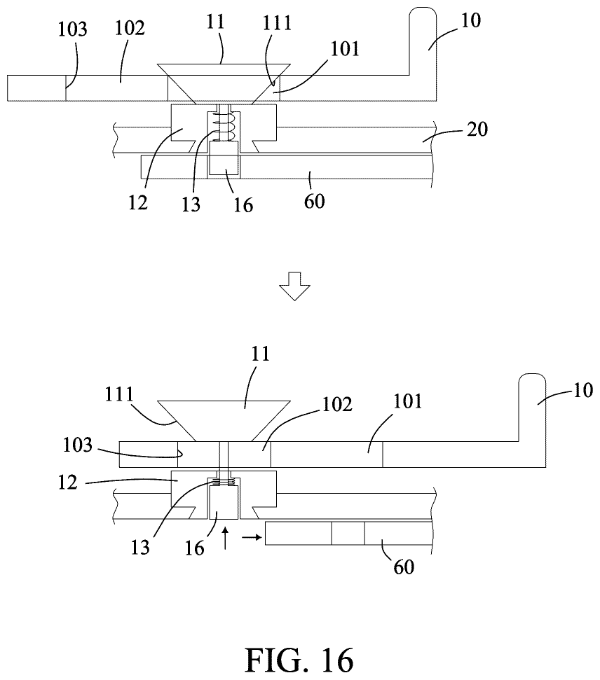

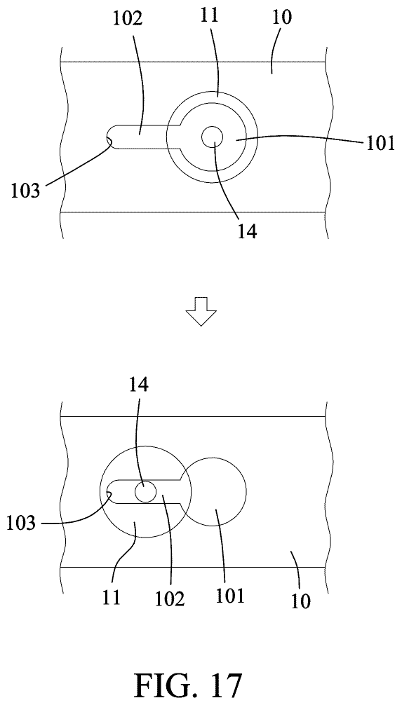

Referring to FIG. 14 to FIG. 17, as shown in the figures: In addition to the above embodiment, in one embodiment of the present disclosure, a difference from the above embodiment is that there may be one, two, or more elastic buckle bodies 1. During use, the buckled object 10 can move to drive a buckling portion 16 of the buckling head portion 11. For example: the buckling head portion 11 is driven to move up or down, to cause the buckling portion 16 to buckle or unbuckle a buckled body 60. The buckled body 60 can be a shell, a handle, a heat sink, a tube body, a chip, a heating element, a plastic body, a connector, an optical fiber, a silicon photon, a tube body, a chip, a heating element, a plastic body, a connector, an optical fiber, a silicon photon, a circuit board, a cabinet body, a sliding rail, a track body, a metal body, or a non-metal body. In this way, the elastic buckle body 1 of the present disclosure can better meet a need of practical use.

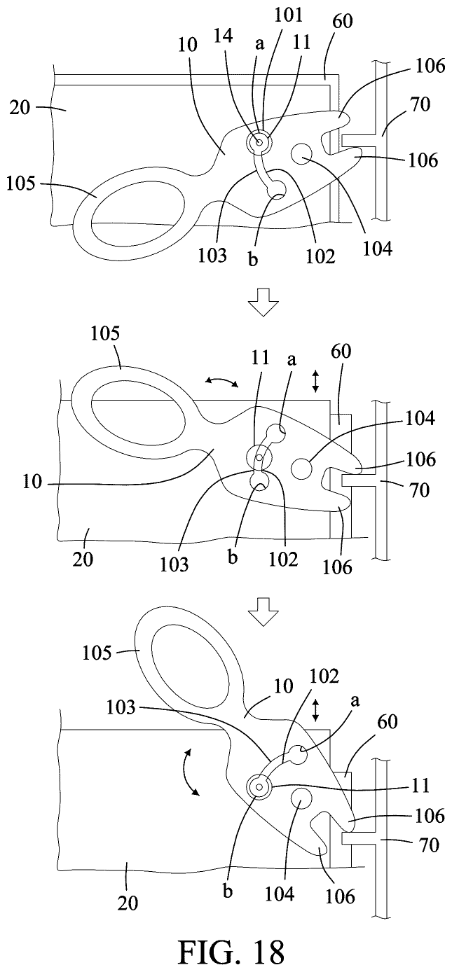

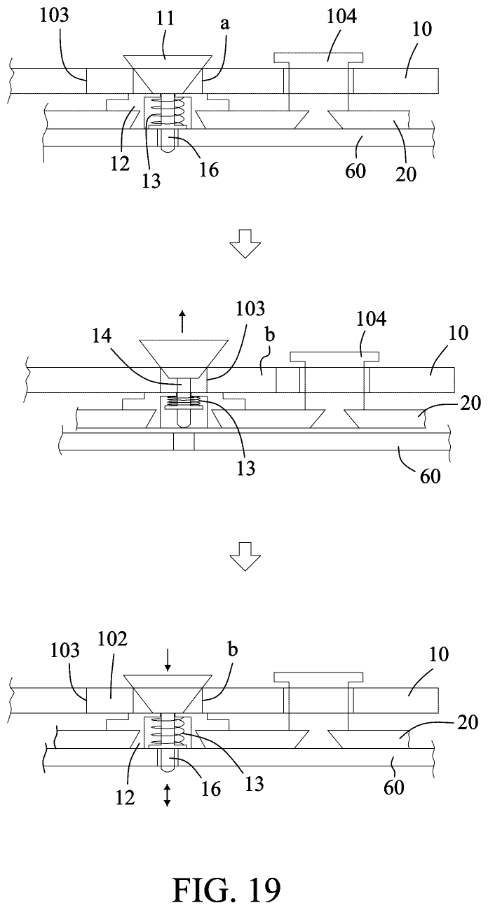

Referring to FIG. 18 and FIG. 19, as shown in the figures: In addition to the above embodiment, in one embodiment of the present disclosure, a difference from the above embodiment is that the restriction portion 101 is connected to an arc-shaped or non-linear moving portion 102 and a resisting portion 103, and the buckled object 10 has an assembling portion 104 for being assembled to the object 20. In this way, a force can be applied to a manual control portion 105 of the buckled object 10, so that the buckled object 10 rotates around the assembling portion 104 serving as an axis, and the buckling head portion 11 performs arc-shaped or non-linear movement for buckling in the moving portion 102 and the resisting portion 103. The buckling head portion 11 performs arc-shaped or non-linear lifting or buckling through the resisting portion 103, and then a pushing portion 106 pushes a pushing body 70 to drive the object 20. In addition, a buckling portion 16 of the elastic buckle body 1 is buckled with the buckled body 60. Thus, when the resisting portion 103 performs arc-shaped or non-linear motion, the buckling portion 16 can be lifted to allow the buckled object 10 (or the object 20) to move or to restrain the buckled object 10 (or the object 20), so that the buckling portion 16 performs buckling motion at two buckling positions (such as a first buckling position a and a second buckling position b) of the buckled body 60, so as to control the buckled object 10 to be in an opening position or a closing position of the pushing portion 106 or to control the buckling portion 16 to buckle or unbuckle the buckled body 60.

In addition to the above embodiment, in one embodiment of the present disclosure, a difference from the above embodiment is that the restriction portion 101 can alternatively be an arc-shaped or non-linear moving portion 102 or resisting portion 103, so that the present disclosure can meet a need of practical application.

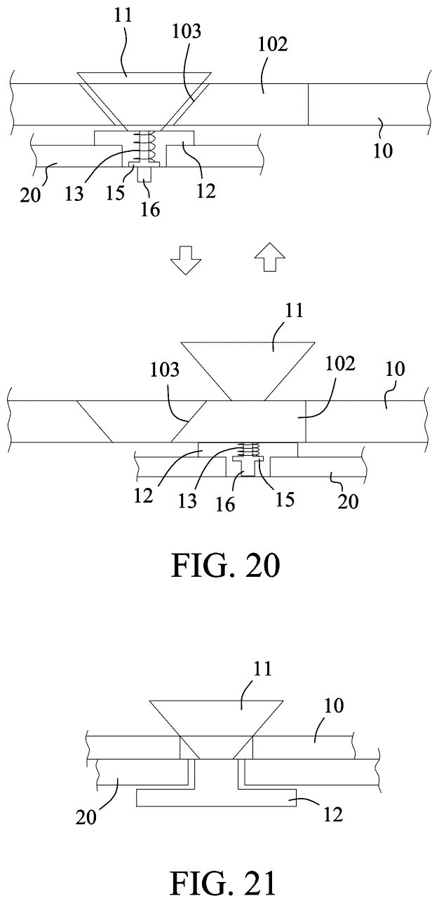

Referring to FIG. 20, as shown in the figure: In addition to the above embodiment, in one embodiment of the present disclosure, a difference from the above embodiment is that the restriction portion 101 is connected to an arc-shaped or non-linear moving portion 102 and a resisting portion 103, and the buckled object 10 has an assembling portion 104 for being assembled to the object 20. In addition, the buckled object 10 has a pushing portion 106 at one end. In this way, a force can be applied to a manual control portion 105 of the buckled object 10, so that the buckled object 10 rotates around the assembling portion 104 serving as an axis, and the buckling head portion 11 performs arc-shaped or non-linear movement for buckling in the moving portion 102 and the resisting portion 103. The buckling head portion 11 performs arc-shaped or non-linear lifting or buckling through the resisting portion 103, and then the pushing portion 106 pushes a pushing body 70 to drive the object 20.

Referring to FIG. FIG. 21, as shown in the figures: In addition to the above embodiment, in one embodiment of the present disclosure, a difference from the above embodiment is that the restriction portion 101 is connected to an arc-shaped or non-linear moving portion 102 and a resisting portion 103, and the buckled object 10 has an assembling portion 104 for being assembled to the object 20. In this way, a force can be applied to a manual control portion 105 of the buckled object 10, so that the buckled object 10 rotates around the assembling portion 104 serving as an axis. The buckling head portion 11 performs arc-shaped or non-linear movement for buckling in the moving portion 102 and the resisting portion 103, and the buckling head portion 11 performs arc-shaped or non-linear lifting or buckling through the resisting Portion 103.

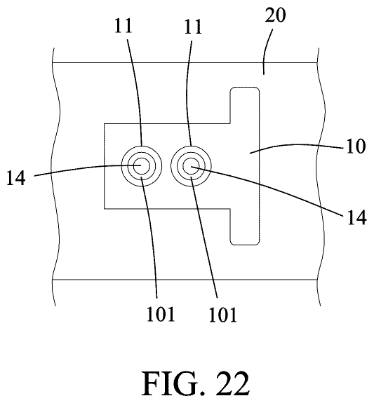

Referring to FIG. FIG. 22, as shown in the figures: In addition to the above embodiment, in one embodiment of the present disclosure, a difference from the above embodiment is that the restriction portion 101 can alternatively be of a simple circular structure. Similarly, after the elastic buckle body 1 can penetrate or pass through the buckled object 10, the buckling head portion 11 and the corresponding portion 14 are buckled to the restriction portion 101 of the buckled object 10. In this way, rapid combination and separation of at least two objects (the buckled object 10 and the object 20) can be completed, and a repeated and rapid combination and separation purpose is achieved.

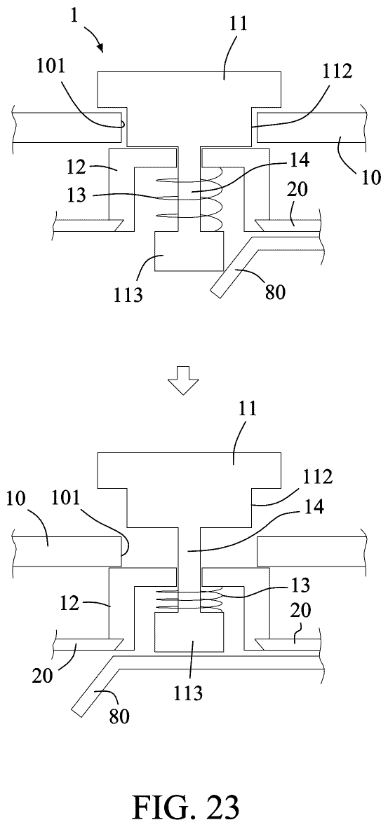

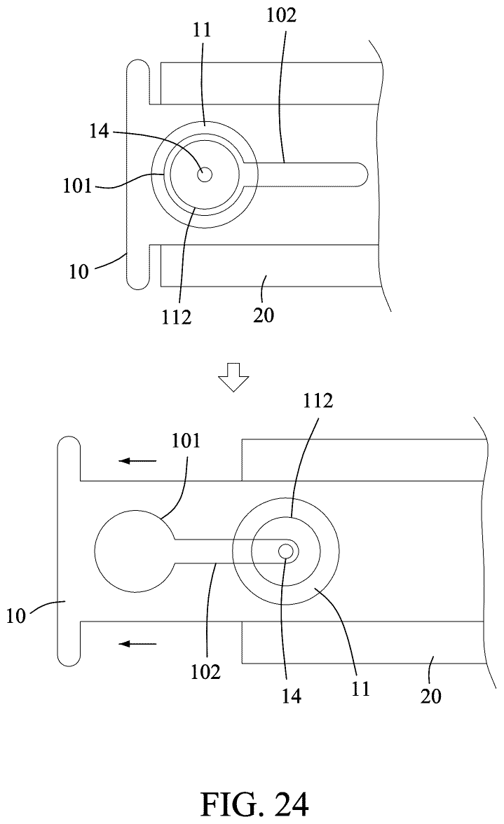

Referring to FIG. 23 and FIG. 24, as shown in the figures: the present disclosure provides an elastic buckling body and a buckling method therefor. The elastic buckle body 1 includes a buckling head portion 11. The elastic buckle body 1 is assembled or arranged at an object 20. The buckling head portion 11 is arranged at a restriction portion 101 of a buckled object 10, so that the buckling head portion 11 limits or temporarily limits the buckled object 10, or the buckling head portion 11 presses, blocks, temporarily presses, or temporarily blocks the buckled object 10. In this way, rapid combination and separation of at least two objects (the buckled object 10 and the object 20) can be completed, and a repeated and rapid combination and separation purpose is achieved.

In addition to the above embodiment, in an embodiment of the present disclosure, a difference from the above embodiment is that the buckling head portion 11 is provided with a position-limiting portion 112. The position-limiting portion 112 is configured to: limit the buckled object 10 and push a lifting portion 113 through a push-upward portion 80, to cause the position-limiting portion 112 to be separated from a restriction portion 101 of the buckled object 10. The restriction portion 101 is larger than the position-limiting portion 112 to move the buckled object 10 or move an object 20. In this way, rapid combination and separation of at least two objects (the buckled object 10 and the object 20) can be completed, and a repeated and rapid combination and separation purpose is achieved.

In addition to the above embodiment, in an embodiment of the present disclosure, a difference from the above embodiment is that the elastic buckle body 1 further includes a body portion 12, an elastic assembly 13, and a corresponding portion 14. The position-limiting portion 112 of the buckling head portion 11 is arranged at one end of the corresponding portion 14, and the lifting portion 113 is arranged at another end of the corresponding portion 14. The corresponding portion 14 is movably arranged at the body portion 12. Two ends of the elastic assembly 13 respectively resist against the body portion 12 and the lifting portion 113, so that the elastic assembly 13 causes the buckling head portion 11 to be normally in a buckled state or normally in an unbuckled state.

Based on the above embodiment, the body portion 12 can be assembled to the object 20, and the buckling head portion 11 then enters the restriction portion 101 of the buckled object 10 for limited buckling, to complete rapid combination of at least two objects (the buckled object 10 and the object 20). In addition, the lifting portion 113 can be pushed by the push-upward portion 80, so that the lifting portion 113 is linked to the corresponding portion 14, the position-limiting portion 112, and the buckling head portion 11, and compresses the elastic assembly 13 at the same time, to cause the position-limiting portion 112 to be separated from the restriction portion 101 of the buckled object 10, thus making the buckled object 10 move and making the object 20 move. In this way, rapid combination and separation of at least two objects (the buckled object 10 and the object 20) can be completed, and a repeated and rapid combination and separation purpose is achieved.

In addition to the above embodiment, in an embodiment of the present disclosure, a difference from the above embodiment is that the restriction portion 101 is connected to a moving portion 102. The buckling head portion 11 is larger than the restriction portion 101. The restriction portion 101 is larger than the moving portion 102. In addition, the restriction portion 101 can be of a closed structure. For example, it can be a hole portion or a slot portion that is of a closed and axially opened structure.

Based on the above embodiment, during use, the body portion 12 can be assembled to the object 20, and the buckling head portion 11 enters the restriction portion 101 of the buckled object 10. The corresponding portion 14 is then moved to the moving portion 102, to cause the buckling head portion 11 to abut against the moving portion 102. The position-limiting portion 112 is buckled to the buckled object 10, or the buckling head portion 11 is moved from the moving portion 102 to the position of the restriction portion 101, and the position-limiting portion 112 is separated from the restriction portion 101 of the buckled object 10 In this way, rapid combination and separation of at least two objects (the buckled object 10 and the object 20) can be completed, and a repeated and rapid combination and separation purpose is achieved.

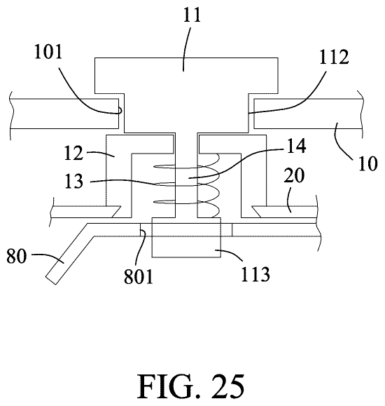

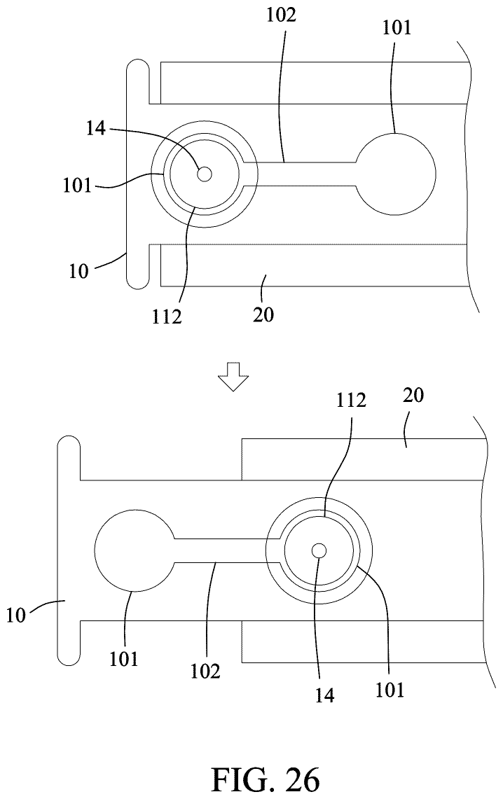

Referring to FIG. 25 and FIG. 26, as shown in the figures: in addition to the above embodiment, in an embodiment of the present disclosure, a difference from the above embodiment is that the lifting portion 113 is configured to be buckled into the push-upward portion 80 or the object 20, or the lifting portion 113 is configured to be buckled into another restriction portion 801 (for example: another restriction portion 801 located on the push-upward portion 80). In this way, rapid combination and separation of at least two objects (the buckled object 10 and the object 20) can be completed, and a repeated and rapid combination and separation purpose is achieved.

In addition to the above embodiment, in an embodiment of the present disclosure, a difference from the above embodiment is that the moving portion 102 is connected to two restriction portions 101. The buckling head portion 11 is larger than the restriction portions 101. The restriction portions 101 are larger than the moving portion 102. Thus, the buckling head portion 11 can enter the restriction portions 101 of the buckled object 10. The corresponding portion 14 is then moved to the moving portion 102, to cause the buckling head portion 11 to abut against the moving portion 102. The position-limiting portion 112 is buckled to the buckled object 10, or the buckling head portion 11 is moved from the moving portion 102 to the position of any restriction portion 101, and the position-limiting portion 112 is separated from any restriction portion 101 of the buckled object 10. In this way, rapid combination and separation of at least two objects (the buckled object 10 and the object 20) can be completed, and a repeated and rapid combination and separation purpose is achieved.

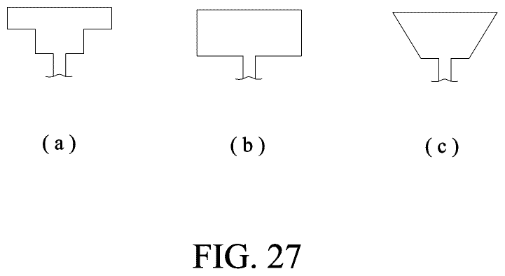

Referring to FIG. 27, as shown in the figures: in addition to the above embodiment, in an embodiment of the present disclosure, a difference from the above embodiment is that the position-limiting portion 112 can be a step portion (such as portion a in FIG. 27), a vertical portion (such as portion b in FIG. 27), a slope portion (such as portion c in FIG. 27), or a right-angle portion (such as a portion, connected to a step, of portion a in FIG. 27). In this way, the position-limiting portion 112 can be more in line with an actual buckling requirement.

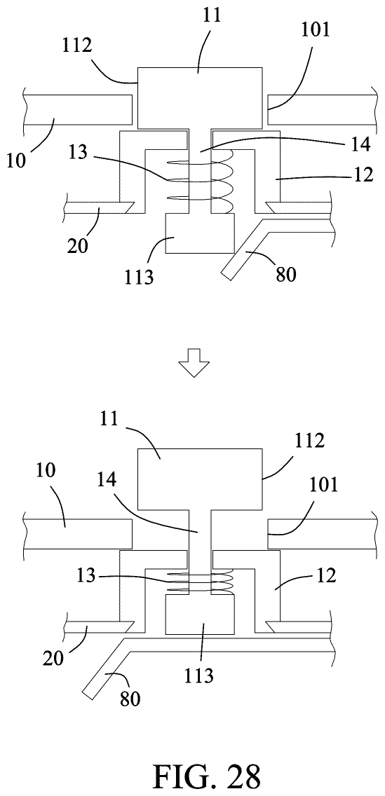

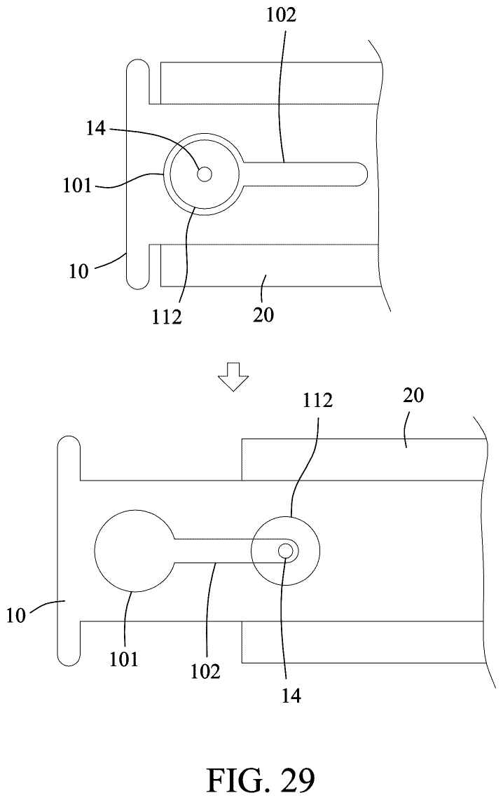

Referring to FIG. 28 and FIG. 29, as shown in the figures: in addition to the above embodiment, in an embodiment of the present disclosure, a difference from the above embodiment is that the position-limiting portion 112 is a vertical portion. During use, the buckling head portion 11 can enter the restriction portion 101 of the buckled object 10. The corresponding portion 14 is then moved to the moving portion 102, to cause the buckling head portion 11 to abut against the moving portion 102. The position-limiting portion 112 is buckled to the buckled object 10, or the buckling head portion 11 is moved from the moving portion 102 to the position of the restriction portion 101, and the position-limiting portion 112 is separated from the restriction portion 101 of the buckled object 10. In this way, rapid combination and separation of at least two objects (the buckled object 10 and the object 20) can be completed, and a repeated and rapid combination and separation purpose is achieved.

In summary, the elastic buckle body and the buckling method therefor of the present disclosure can complete rapid combination and separation of at least two objects, and achieve a repeated and rapid combination and separation effect.

The above descriptions are merely the embodiments of the present disclosure and are not intended to limit the present disclosure.

What is claimed is:

1. An elastic buckle body, wherein the elastic buckle body comprises a buckling head portion; the buckling head portion is larger than a restriction portion of a buckled object, or the elastic buckle body is assembled or arranged on an object by penetrating or passing through the buckled object, or the elastic buckle body combines or elastically combines the object with the buckled object, or the elastic buckle body and the object clamp the buckled object, or the buckling head portion and the object clamp the buckled object.

2. The elastic buckle body according to claim 1, wherein the restriction portion is connected to a moving portion to allow a corresponding portion smaller than the buckling head portion to enter.

3. The elastic buckle body according to claim 1, wherein the elastic buckle body further comprises a body portion, an elastic assembly, a corresponding portion, or a blocking portion, or the buckling head portion is arranged at one end of the corresponding portion, or the blocking portion is arranged at another end of the corresponding portion, or the corresponding portion is movably arranged on the body portion, or two ends of the elastic assembly respectively resist against the body portion and the blocking portion or the corresponding portion.

4. The elastic buckle body according to claim 1, wherein the elastic buckle body further comprises a body portion and an elastic assembly; and the restriction portion is connected to a moving portion and a resisting portion, or the resisting portion is smaller than the buckling head portion, or the resisting portion is smaller than the restriction portion or is configured to elastically resist against the buckling head portion and the body portion or to provide a lifting distance between the buckling head portion and the body portion.

5. The elastic buckle body according to claim 1, wherein the elastic buckle body further comprises a body portion and an elastic assembly; and the restriction portion is connected to a resisting portion, or the resisting portion is smaller than the buckling head portion, or the resisting portion is smaller than the restriction portion or is configured to resist against the buckling head portion or to provide a lifting distance between the buckling head portion and the body portion.

6. The elastic buckle body according to claim 1, wherein the elastic buckle body further comprises a body portion, and the buckling head portion is movably arranged on the body portion, or the body portion is riveted, welded, expanded, or locked to the object, or the body portion is integrally formed with the object.

7. The elastic buckle body according to claim 1, wherein the buckled object or the object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body; or the object is provided with a heating element, or the buckled object is a heat sink, or the buckled object is provided with a heat sink, or the heating element is a chip, an integrated circuit (IC), or an electric body, or the buckled object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body, or the object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body; or the buckled object or the object is configured to be assembled with one, two, or more elastic buckle bodies, or to resist against the buckled object and the object, or to press against the buckled object or the object.

8. The elastic buckle body according to claim 1, wherein the buckling head portion is configured to lift a resisting portion, or the buckling head portion elastically presses against the buckled object; or the buckling head portion is provided with a slope, a curved surface, a flat surface, an arc surface, a stepped surface, a convex portion, or a concave portion, or the buckled object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body, or the object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body.

9. The elastic buckle body according to claim 1, wherein the restriction portion is connected to a moving portion and a resisting portion, or the buckling head portion is larger than the restriction portion, or the restriction portion is larger than the moving portion and the resisting portion, or the resisting portion is larger than the moving portion, or the resisting portion is equal to or smaller than the moving portion, or the moving portion is the resisting portion.

10. The elastic buckle body according to claim 1, wherein the elastic buckle body further comprises a body portion; the buckling head portion is movably arranged on the body portion; the body portion is provided with a material restriction portion, or a mold applies a pressure, so that a material of the object enters or flows into the material restriction portion, to rivet the body portion to the object; or the elastic buckle body further comprises a body portion; the buckling head portion is movably arranged on the body portion; the body portion is provided with an expansion portion, or a mold applies a pressure, so that the expansion portion deforms and is expanded to the object; or the elastic buckle body further comprises a body portion; the buckling head portion is movably arranged on the body portion, and the body portion is provided with a welding portion, or is configured to weld the body portion to the object through the welding portion; or the elastic buckle body further comprises a body portion; the buckling head portion is movably arranged on the body portion; the body portion is provided with a locking portion, or is configured to lock the body portion to the object through the locking portion; or the elastic buckle body further comprises a body portion; the buckling head portion is movably arranged on the body portion; the body portion is provided with a latching portion; the latching portion is configured to cooperate with a fixing member, so that the body portion is locked to the object through the latching portion and the fixing member; or the elastic buckle body further comprises a body portion; the buckling head portion is movably arranged on the body portion; and the body portion is integrally formed with the object.

11. The elastic buckle body according to claim 1, wherein the elastic buckle body is assembled to the object from top to bottom or from bottom to top, or the elastic buckle body is assembled to the object from top to bottom or from bottom to top through the restriction portion, to limit the buckling head portion to the buckled object.

12. The elastic buckle body according to claim 1, wherein the buckling head portion is configured to clamp the buckled object or the object from top to bottom or from bottom to top together with the body portion, or to simultaneously clamp the buckled object and the object, or the buckling head portion is configured to clamp the buckled object from top to bottom or from bottom to top together with the object, or to simultaneously clamp the buckled object and the object.

13. The elastic buckle body according to claim 1, wherein the restriction portion is of a closed structure, or the restriction portion is of a laterally closed and axially opened structure, or the restriction portion is a hole or a slot, or the restriction portion is a step.

14. The elastic buckle body according to claim 1, further comprising a body portion and an elastic assembly that are mutually movably combined, wherein the body portion is assembled or arranged on the object, and the buckling head portion is configured to buckle or clamp the buckled object; or the buckling head portion and the body portion are abutted and combined by two surfaces of the buckled object, so that the buckling head portion and the body portion clamp the buckled object.

15. The elastic buckle body according to claim 1, wherein the buckled object or the object is configured to be assembled with one, two, or more elastic buckle bodies, or to resist against the buckled object and the object, or to resist against the buckled object or the object.

16. The elastic buckle body according to claim 1, wherein the elastic buckle body further comprises a corresponding portion and a blocking portion, or the buckling head portion is arranged at one end of the corresponding portion, or the blocking portion is arranged at another end of the corresponding portion, or the corresponding portion is movably arranged on the body portion, or two ends of the elastic assembly respectively resist against the body portion and the blocking portion.

17. The elastic buckle body according to claim 16, wherein the buckling head portion, the corresponding portion, or the blocking portion is assembled to the body portion from top to bottom or from bottom to top, or the body portion, the corresponding portion, or the blocking portion is assembled to the buckling head portion from top to bottom or from bottom to top, or clamps the buckled object or the object together with the buckling head portion.

18. The elastic buckle body according to claim 1, wherein the buckled object moves to drive a buckling portion of the buckling head portion or to cause the buckling portion to buckle or unbuckle a buckled body; or the buckled body is a shell, a handle, a heat sink, a tube body, a chip, a heating element, a plastic body, a connector, an optical fiber, a silicon photon, a circuit board, a cabinet body, a sliding rail, a track body, a metal body, or a non-metal body, or the buckled object is a shell, a handle, a heat sink, a tube body, a chip, a heating element, a plastic body, a connector, an optical fiber, a silicon photon, a circuit board, a cabinet body, a sliding rail, a track body, a metal body, or a non-metal body.

19. The elastic buckle body according to claim 1, wherein the restriction portion is connected to an arc-shaped or non-linear moving portion or resisting portion, or the restriction portion is an arc-shaped or non-linear moving portion or resisting portion, or the buckled object has an assembling portion for being assembled to the object, or the assembling portion is used as an axis to make the buckling head portion perform arc-shaped or non-linear movement or buckling in the moving portion or in the resisting portion or perform arc-shaped or non-linear lifting or buckling through the resisting portion.

20. The elastic buckle body according to claim 1, wherein the restriction portion is connected to an arc-shaped or non-linear moving portion or resisting portion, or the restriction portion is an arc-shaped or non-linear moving portion or resisting portion, or the buckled object has an assembling portion for being assembled to the object, or the assembling portion is used as an axis to make the buckling head portion perform arc-shaped or non-linear movement or buckling in the moving portion or in the resisting portion or perform arc-shaped or non-linear lifting or buckling through the resisting portion, or the buckled object has a pushing portion, or the pushing portion is configured to push a pushing body to drive the object.

21. The elastic buckle body according to claim 1, wherein the restriction portion is connected to an arc-shaped or non-linear moving portion or resisting portion, or the restriction portion is an arc-shaped or non-linear moving portion or resisting portion, or the buckled object has an assembling portion for being assembled to the object, or the assembling portion is used as an axis to make the buckling head portion perform arc-shaped or non-linear movement or buckling in the moving portion or in the resisting portion or perform arc-shaped or non-linear lifting or buckling through the resisting portion, or the buckled object has a pushing portion; or the pushing portion is configured to push a pushing body to drive the object, or the elastic buckle body has a buckling portion to buckle a buckled body, or when the resisting portion performs the arc-shaped or non-linear motion, the buckling portion is lifted to make the object or the buckled object move or to restrain the object or the buckled object, or the buckling portion performs buckling motion at two buckling positions of the buckled body or is configured to control the buckled object to be in an opening position or a closing position of the pushing portion or to control the buckling portion to buckle or unbuckle the buckled body.

22. The elastic buckle body according to claim 1, wherein the restriction portion is connected to an arc-shaped or non-linear moving portion or resisting portion, or the restriction portion is an arc-shaped or non-linear moving portion or resisting portion, or the object has a shaft body to make the buckling head portion perform arc-shaped or non-linear movement or buckling in the moving portion or in the resisting portion or perform arc-shaped or non-linear lifting or buckling through the resisting portion, or the buckled object has a pushing portion; or the pushing portion is configured to push a pushing body to drive the object, or the elastic buckle body has a buckling portion to buckle the buckled body, or the buckling portion is configured to buckle or unbuckle a buckled body to restrict or release movement of the object, or the object or the buckled body is a case or a main board, or is configured to lift the buckling portion when the resisting portion performs arc-shaped or non-linear motion; or the buckling portion performs buckling motion at two buckling positions of the buckled body or is configured to control the buckled object to be in an opening position or a closing position of the pushing portion or to control the buckling portion to buckle or unbuckle the buckled body.

23. The elastic buckle body according to claim 1, wherein the buckling head portion is provided with a position-limiting portion; the position-limiting portion is configured to: limit the buckled object and push a lifting portion through a push-upward portion, to cause the position-limiting portion to be separated from a restriction portion of the buckled object; or the restriction portion is larger than the position-limiting portion to move the buckled object or move an object; or the lifting portion is configured to be buckled into the push-upward portion or the object, or the lifting portion is configured to be buckled into another restriction portion; or the restriction portion is connected to a moving portion to allow a corresponding portion smaller than the buckling head portion to enter.

24. The elastic buckle body according to claim 1, wherein the elastic buckle body further comprises a body portion, an elastic assembly, a corresponding portion, or a blocking portion, or the buckling head portion is arranged at one end of the corresponding portion, or the blocking portion is arranged at another end of the corresponding portion, or the corresponding portion is movably arranged on the body portion, or two ends of the elastic assembly respectively resist against the body portion and the blocking portion or the corresponding portion.

25. The elastic buckle body according to claim 1, wherein the buckled object has a restriction portion; and the restriction portion is connected to a moving portion or a resisting portion, or the buckling head portion is larger than the resisting portion, or the resisting portion is larger than the moving portion and the resisting portion, or the resisting portion is larger than the moving portion, or the resisting portion is equal to or smaller than the moving portion, or the moving portion is the resisting portion.
